(19) United States
(12) Patent Application Publication
(10) Pub. No.: US 2025/0355015 A1
(43) Pub. Date: Nov. 20, 2025

(54) Nitric-Oxide Ionization Induced Flow Tagged Imaging (NiiFTI)

(71) Applicant: The Texas A&M University System, College Station, TX (US)

(72) Inventors: Boris S. LEONOV, Bryan, TX (US); Richard B. MILES, Bryan, TX (US)

(21) Appl. No.: 18/904,408

(22) Filed: Oct. 2, 2024

Related U.S. Application Data
(60) Provisional application No. 63/587,532, filed on Oct. 3, 2023.

(51) Int. Cl. G01P 5/00

(52) U.S. Cl. CPC G01P 5/001

(57) ABSTRACT

Nitric-oxide ionization induced flow tagging and imaging (NiiFTI) is described. In one embodiment a method for characterizing a flow of a gas containing an agent includes ionizing the agent by a source of pulsed light emitting at a frequency overlapping a resonant transition frequency of the agent. In response to ionizing of the agent, a fluorescence of the gas is generated. The method also includes capturing at least one time-delayed image of the flow of the gas, where the capturing is time-delayed with respect to a pulse of the source of pulsed light. The method includes determining at least one property of the flow of the gas by analyzing the at least one time-delayed image of the flow.

### CROSS-REFERENCE TO RELATED APPLICATION

This application claims the benefit of U.S. Patent Application No. 63/587,532, filed Oct. 3, 2023, the disclosure of which is hereby incorporated by reference in its entirety.

### STATEMENT OF GOVERNMENT LICENSE RIGHTS

This invention was made with government support under the Office of Naval Research under grant number N00014-23-1-2458. The government has certain rights in the invention.

### BACKGROUND

Velocity, temperature, pressure, and chemical composition are essential parameters required for the understanding of the parameters of turbulent and reacting flows. To measure such flow parameters, some conventional technologies rely on seeding particles into the flow, followed by observing trajectories of the particles to deduce flow properties, for example velocity or vorticity of the flow. However, while conventional particle tracking methods have been successful for low-speed flows, hypersonic flows are difficult to seed with particles and the particle motion often does not follow the flow.

One conventional technology particle tracking method is known as a Molecular Tagging Velocimetry (MTV) techniques. The MTV has been developed and is now broadly applied for non-intrusive velocity measurements, especially for applications where direct measurement of molecular motion is required. However, MTV relies on the use of multiple lasers for tagging and subsequent interrogation by laser-induced fluorescence. For example, the first MTV in air required two laser wavelengths for vibrational tagging of molecular oxygen and an additional ultraviolet laser for interrogation. The use of separate laser pulses for tagging and interrogation (also referred to as “write-read” methods) limits the utility of the approaches to a single sample of the molecular displacement and through the complexity of overlapping the interrogation laser with the displaced molecules.

Another conventional technology is known as Femtosecond Laser Electronic Excitation Tagging (FLEET). This conventional technology does not require multiple lasers, but the laser systems for the flow tagging in large-scale facilities currently operate at kilohertz rates. However, for short-duration phenomena, such as those found in hypersonic flows, significantly higher rates are desirable for diagnostics of these unsteady environments.

Yet another conventional technology, Picosecond Laser Electronic Excitation Tagging (PLEET), operates at high repetition rates, but does not tag the flow as effectively as FLEET. Current experimental efforts are underway to bring FLEET and PLEET to 100 s of kHz repetition rates and large spatial scales with successful demonstrations published using custom high-power lasers and tailored applications. Recent advances in Krypton Tagging Velocimetry (KTV) have yielded successful 100 kHz, single laser flow tagging. However, this method requires krypton seeding and a high-power narrow-linewidth ultraviolet laser tuned onto a specific resonant two-photon excitation transition.

Accordingly, systems and methods for improved interrogation of hypersonic flow and, more generally, unsteady, turbulent and reacting flows are still needed.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

The inventive technology is directed to methods and systems for flow velocimetry. In particular, the inventive Nitric-oxide Ionization Induced Flow Tagging and Imaging (NiiFTI) technology relies on an energy transfer processes from “one plus one” two-photon resonantly ionized nitric oxide (NO) to electronically excited molecular nitrogen (N₂) and its subsequent long “red” phosphorescence. The first positive fluorescence from molecular nitrogen lasts on the order of 10 s-100 s of microseconds in air, enabling quantitative tracking of the “tagged” line displacement in time. The NiiFTI method enables flow tagging with a single sub-millijoule nanosecond laser pulse and tracking of the “written” pattern with a time-gated camera. In some embodiments, multiple (at least two) camera images are acquired. These camera images are spaced closely apart in time, thus representing locations of the same set of fluid particles at two subsequent times. Next, by comparing the locations of these fluorescencing fluid particles, flow properties (e.g., velocity, vorticity, etc.) can be derived by a suitable image interrogation system.

System simplicity is of particular benefit for supersonic, hypersonic, and combustion ground test facilities where multi-system synchronization may be difficult or precluded. Since this method is compatible with commercially available systems and uses NO planar laser-induced fluorescence (PLIF) excitation scheme (226 nm, A−X(0,0) transition), it is of particular utility as the laser setup can be retrofitted from those used for PLIF.

Although NiiFTI requires the presence of nitric oxide (NO), it is naturally present in high enthalpy ground test facilities operating with air due to reactions in the plenum, in the expansion tube acceleration section, or behind shock waves. Otherwise, it can be introduced artificially through seeding. Generally, nitric oxide mole fraction of less than 1 percent is required.

### BRIEF DESCRIPTION OF THE DRAWINGS

The foregoing aspects and many of the attendant advantages of the claimed subject matter will become more readily appreciated as the same become better understood by reference to the following detailed description, when taken in conjunction with the accompanying drawings, wherein:

FIG. 1 is a schematic of an experimental setup in accordance with embodiments of the present technology;

FIG. 2 is a graph of operation of the of the experimental system shown in FIG. 1;

FIG. 3 is a graph of camera images in accordance with embodiments of the present technology;

FIG. 4 is an integrated average image of the graph of FIG. 3;

FIG. 5 is a flow chart of flow measurements in accordance with embodiments of the present technology;

FIG. 6 illustrates raw images of tagged boundary layer obtained in accordance with embodiments of the present technology;

FIG. 7 shows experimental results of velocity measurements shown in FIG. 6; and

FIG. 8 shows experimental results of velocity measurements in accordance with embodiments of the present technology.

### DETAILED DESCRIPTION

While illustrative embodiments have been illustrated and described, it will be appreciated that various changes can be made therein without departing from the spirit and scope of the invention.

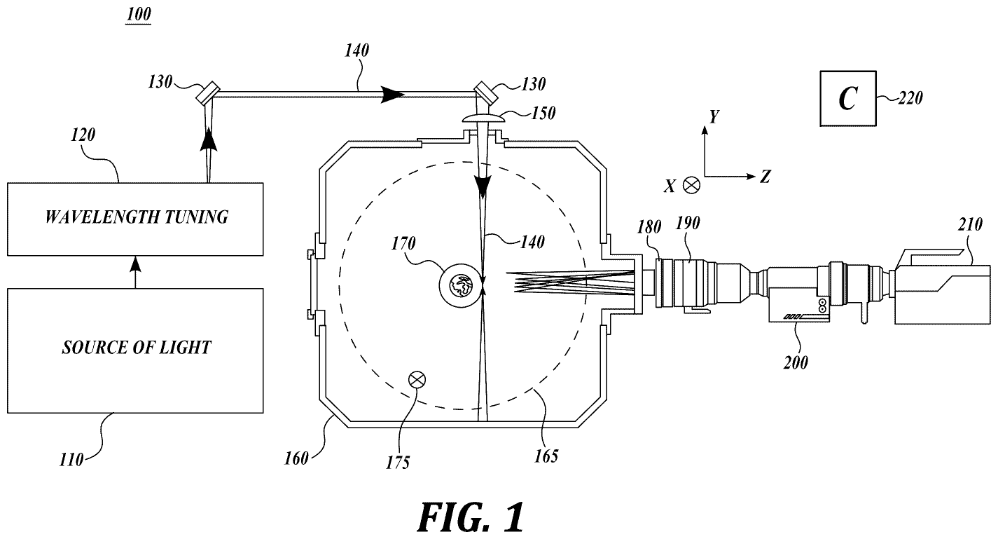

FIG. 1 is a schematics of an experimental setup in accordance with embodiments of the present technology. The illustrated NiiFTI experimental setup 100 is capable of characterizing flow of gas at hypersonic velocities. In operation, a source of light (e.g., an Nd:YAG laser) 110 generates pulses of light at a set repetition rate. A wavelength tuning device (e.g. an optical parametric oscillator (OPO) or a frequency upconverted dye laser) 120 operates to tune the source of light to the right wavelength to facilitate coupling into nitric oxide (NO).

In some embodiments, a third harmonic of Spectral Energies QuasiModo pulse-burst laser pumps Spectral Energies burst-mode optical parametric oscillator (OPO) at 100 kHz with a burst duration of 500 μs. The OPO 120 generates a 623 nm signal and an 823 nm idler beams. The generated signal beam is mixed with the residual 355 nm laser radiation to produce a narrowband 226.102 nm (vac.) beam resonant with overlapping Q₂(20)+Q₂₁(20)+Q₁(212) transitions of the A²Σ⁺(v′=0)←X²Π_{1/2} (v″=0) band of nitric oxide (NO). Therefore, the OPO 120 generates a frequency that is overlapping with a resonant transition frequency of nitric oxide, which also referred to as an “agent” because NO subsequently transfers excitation to nitrogen (N₂) molecules.

Thus generated 226 nm beam 140 can be routed into the hypersonic wind tunnel test section thorough mirrors (or other optical elements) 130, before being focused with a focusing lens 150 (e.g., a 1000 mm focusing lens) tangentially to the surface of a test article 170. The pulse energy measured inside the test section fluctuates near or below 1 mJ per pulse.

A person of ordinary skill would understand that the above setup is just one example of providing the laser light beam 140 into a test chamber 160, but other combinations of source of light, wavelength tuning devices, and routing optics are also possible. For example, a grid to the laser light beams 140 in the vicinity of the test article 170 can be created by suitable optics for better resolution of the flow. The test chamber 160 includes optically transparent windows on the top, bottom, and one of the tunnel sides, which provide good optical access for both the laser beam 140 and the camera setup. As explained above, the illustrated NiiFTI method enables flow tagging with a single sub-millijoule nanosecond laser pulse.

In some embodiments, the test article 170 is subjected to high speed flow, e.g., a hypersonic flow of about Mach 8.5-10. The test article 170 of an ogive canonical shape with a blunt nose tip may be selected as a test article of interest for the experiment as its positive pressure gradients stabilize the boundary layer transition making it an active field of research and a relevant testbed for boundary layer velocimetry demonstration. In the illustrated embodiment, direction of the flow is into the plane of paper, as illustrated by symbol 175. Line 165 represents an outline of a nozzle exit of the illustrated hypersonic wind tunnel. In some embodiments, the diameter of the beam spot 140 at the vicinity of the test article 170 is approximated at less than 100 μm based on burn paper and Rayleigh scattering captured by the camera setup. In some embodiments, the UV energy per pulse reaches 0.5-1 mJ inside the wind tunnel.

In some embodiments, the hypersonic flow will naturally generate sufficient amount of nitric oxide (agent) that is excited by an energy transfer processes from “one plus one” two-photon resonantly ionized nitric oxide (NO) that includes a first resonant excitation step having a single or multi photon resonant excitation of NO (the agent); and a second ionization step that includes ionization of the NO itself. The process continues to ionically excite molecular nitrogen (N₂) into its subsequent long-lasting “yellow-orange-red” fluorescence.

Stated differently, a fluorescence of the N₂ gas is generated in response to ionizing of the NO (agent). In some embodiments, if the natural production of NO is insufficient, the flow can be seeded with nitric oxide such that, for example, the freestream mole fraction of NO does not exceed 0.8%.

For the illustrated wedge test article 170, the region of interest for the measurements may be located 40 cm downstream from the leading edge to ensure the developed boundary layer.

The long-lasting “yellow-orange-red” fluorescence of N₂ gas may be collected with a camera 210 (e.g., Shimadzu HPV-X2 synchronized with the laser at 100 kHz) equipped with an intensifier 200 (e.g., Lambert HiCATT GaAsP, P46), and a lens 190 (e.g., Nikon AF-S NIKKOR 200 mm 1:2 GII ED). In order to suppress a strong background luminescence from the high-enthalpy flow, a 600 nm Schott colored glass filter 180 was used. The combination of the colored glass filter 180 (also referred to as a longpass filter) and the intensifier sensitivity curve led to the acquisition band of 600 nm-750 nm, which works reasonably well for the hypothesized first positive system emission of nitrogen molecules. In some embodiments, the intensifier (also referred as intensified relay optic or IRO) 200 operates as a double-gated mode with the first gate (e.g., 200 ns delay w.r.t. the laser, 50 ns width) and the second gate (e.g., 1750 ns or 2200 ns delay w.r.t. the laser, 500 ns width) overlapped on the same camera image. Operation of the experimental setup 100 may be controlled by a controller 220. A set of sample experimental conditions is shown in Table 1 below.

TABLE 1
Experimental freestream conditions (predicted)

| | Condition 1 | Condition 2 | Condition 3 |
|---|---|---|---|
| Mach | 10 | 10 | 8.5 |
| $Enthalpy \frac{MJ}{kg}$ | 4.41 | 4.44 | 3.87 |
| Velocity [m/s] | 2898 | 2907 | 2690 |
| Tₛₜ + [K] | 209 | 210 | 251 |
| Pₛₜ [kPa] | 2.3 | 2.4 | 3.9 |
| Re [m⁻¹] | 8.2E+6 | 8.3E+6 | 9.1E+6 |
| Location | Boundary | Outside BL | BL |
| | layer (BL) | | |

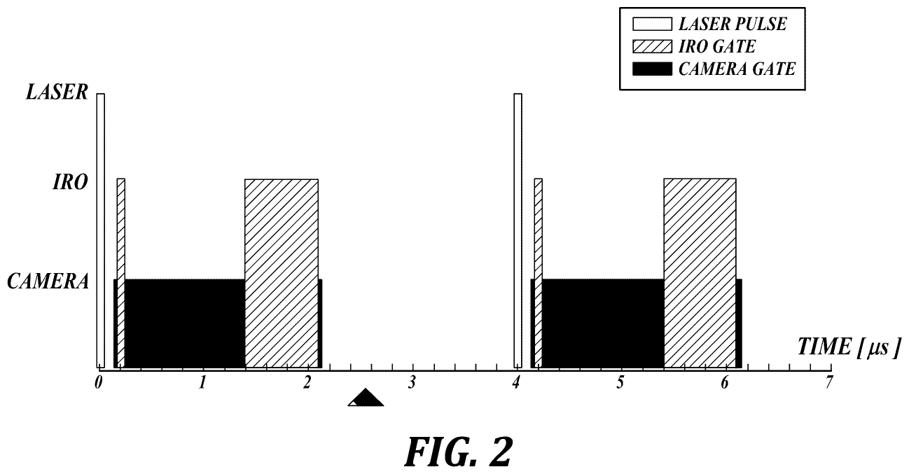

FIG. 2 is a graph of operation of the of the experimental system shown in FIG. 1. The horizontal axis corresponds to time. The vertical axis illustrates a sequence of events: laser pulse, IRO gate, and camera gate. Two consecutive laser pulse/camera acquisition events are illustrated. Each of the two events includes a laser pulse event, followed by a double-gated mode with the first gate and the second gate overlapped on the same camera image. Therefore, capturing of the camera image is time-delayed with respect to the laser pulse. For each event, the first IRO gate is characterized by a 200 ns delay with respect to the laser, and a 25-50 ns width, and the second IRO gate is characterized by 1750 ns or 2200 ns delay with respect to the laser pulse, and a 500-700 ns width. The camera gate may be understood as the time span during which the pixels of the camera are electronically exposed to the fluorescence of the N2 molecules in the hypersonic flow. In the illustrated embodiment of FIG. 2, each laser pulse is followed by a gated (time-delayed) camera image acquisition. However, in other embodiments multiple time-delayed images of the flow of the gas may be acquired with reference to the same laser pulse. These multiple time-delayed images may be characterized by different time delays that allow the flow being imaged to further develop from a shorter time-delay to a longer time-delay. In some embodiments, the multiple time-delayed images may be captured within a single camera frame that spans over the first time-delay and the second time-delay. In other embodiments, separate camera frames may be used for the images obtained after the first time-delay and the second time-delay.

In the embodiment of FIG. 2, the maximum camera gate of the sample Shimadzu HPV-x2 camera operated at 250 kHz (2000 ns) is precisely synchronized to capture both IRO exposures. Such camera's ability to operate at high repetition rates is useful for the laser pulse repetition that can also operate at, for example, 100-250 kHz rate.

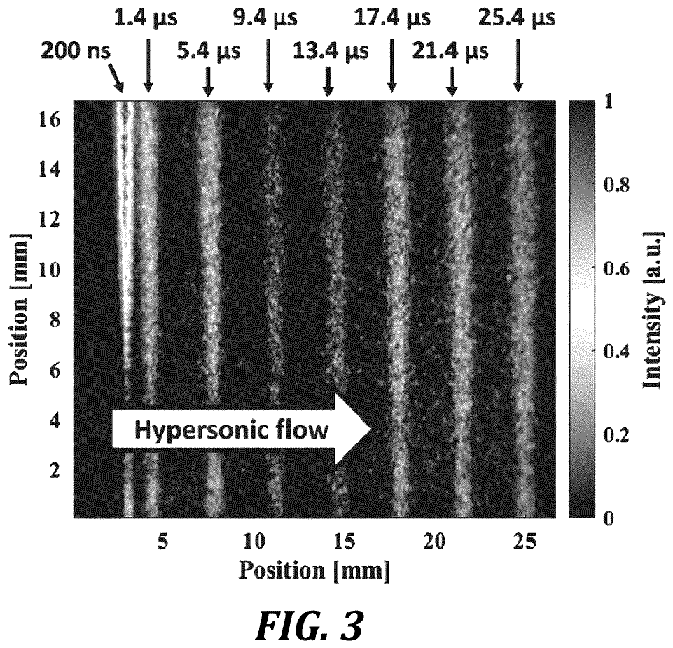

FIG. 3 is a graph of camera images in accordance with embodiments of the present technology. The horizontal axis corresponds to Z-coordinate and vertical axis correspond to Y-coordinate illustrated in FIG. 1. In particular, the region of interest was located around 35 mm above the wedge surface and 26 cm behind the leading edge (completely outside the boundary layer) of a 2.75° half-angle wedge test article. The intensity of N₂ fluorescence is shown in arbitrary units. The Mach number is 5.68. In the illustrated experiment, the longpass filter 180 is a 550 nm longpass filter.

The graph shows a fifty-frame average camera image with displaced tagged lines and the corresponding time delays identified. The initial vertical laser line is “written” perpendicularly to the flow direction at around 2.5 mm position horizontal scale and then displaced by the flow over time. Due to the triple exponential decay characteristic of the NiiFTI signal, the first camera gate was delayed by 200 ns (only 25 ns width) in order to avoid the strongest fluorescence from the 10 s and 100 s nanosecond decays as well as to balance the signal level with the second IRO gate at 1.4 μs delay (700 ns width). Tagged lines from these two gates are the first two visible at 2.7 mm and 4.5 mm locations. While the camera was synchronized with the laser and one image was taken for each laser pulse, due to a very long fluorescence lifetime associated with the NiiFTI signal, the long IRO gate was able to capture fluorescence from previous laser pulses creating six additional “tagged” lines in the image between 7 and 26 mm horizontal position. Due to the 28 times shorter exposure of the first IRO gate and a low signal level, the first gate was not identified in the preceding laser pulse fluorescence. Based on the line intensities, the two longer lifetimes (1/e) were calculated at 270 ns and 45 μs, which is considerably longer than the FLEET signal lifetime (400 ns) that was reported previously for this wind tunnel under similar conditions. The observed broadening of the tagged line over time is attributed to local laser and subsequent recombination heating (O(50° K)) with gas diffusion effects estimated to be negligibly small for these time scales.

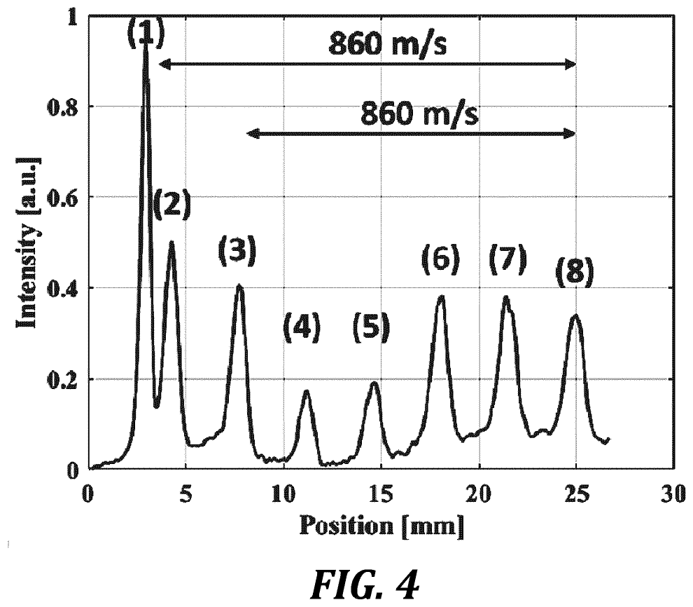

FIG. 4 is an integrated average image of the graph of FIG. 3. When integrated over the vertical spatial domain, the image shown in FIG. 3 produces an easier-to-interpret signal distribution as a function of the horizontal position. Each of the eight lines identified in the figure is fitted with a Gaussian fit for precise centroid location and 95% confidence interval identification. Due to a significantly longer fluorescence lifetime in comparison to the IRO lines, the decay correction, which would be problematic for some conventional technologies, was deemed negligible. The velocity is calculated based on the two centroid locations and centers of IRO gate delays. Some examples of the calculated velocities are shown in FIG. 4 as example velocity of 860 m/s. Due to a lower sensitivity of the intensifier between 10 mm and 17 mm, lines (4) and (5) had abnormally lower intensity in comparison to other lines.

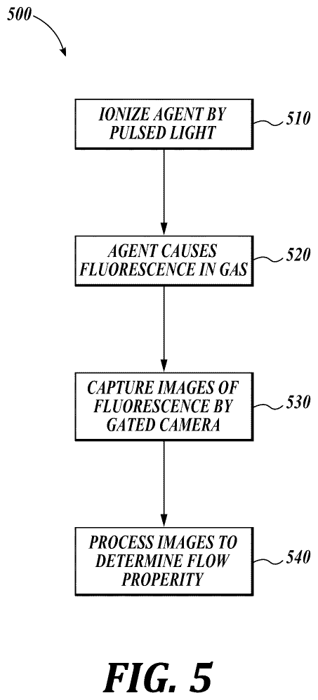

FIG. 5 is a flow chart 500 of flow measurements in accordance with embodiments of the present technology. In different embodiments, the illustrated method may have additional steps or fewer steps. In block 510, an agent in the flow (e.g., NO that is naturally present or seeded into the flow) is ionized by a laser pulse at the target wavelength. The wavelength may be tuned by, for example, the OPO 120. In many embodiments, a single nanosecond laser pulse with sub-millijoule energy suffices to excite the NO. In some embodiments, the laser pulse may be optically spread into a grid of laser lines to provide increased and spatially disperse excitation of NO, resulting in increased spatial resolution of flow property measurements.

In block 520, the nitric oxide (NO) that is excited by an energy transfer processes from “one plus one” two-photon resonantly ionized nitric oxide (NO), transfers energy to molecular nitrogen (N₂) that is characterized by subsequent long-lasting “yellow-orange-red” fluorescence. A person of ordinary skill would recognize that N₂ is the most numerous gas molecule in any airflow.

In block 530, the consecutive images of the fluorescent N₂ are captured by, for example, the camera system shown in FIG. 1 based on the time gating shown in FIG. 2. The repetition rate of the camera gating may be selected to match the repetition rate of the laser pulses that is, for example, within 100-250 kHz.

In block 540, velocity, vorticity, or other flow property may be determined based on the known time delays between the two consecutive captures of lines or grids of the fluorescent N₂ using image interrogation methods known to a person of ordinary skill.

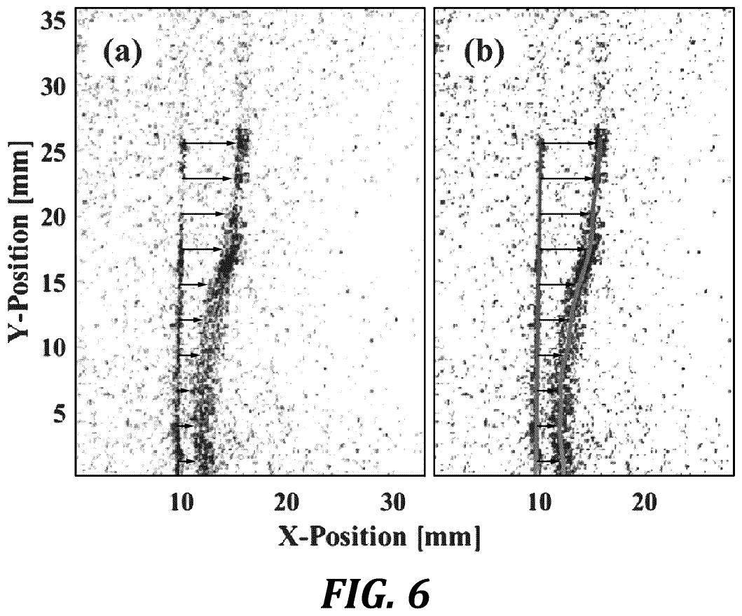

FIG. 6 illustrates raw images of tagged boundary layer obtained in accordance with embodiments of the present technology. Two images are illustrated. The image (a) on the left hand side is a raw image of a tagged boundary layer, while the image (b) on the right hand side includes a fitted tagged line locations. Each graph includes two consecutive images of the tagged flow (i.e., the flow that includes fluorescent molecules of N₂). Time spacing between the two lines corresponds to 2 μs, which, in turn, corresponds to condition 1 (Mach 10) shown in Table 1. The arrows connecting the two time-events represent a crude attempt to approximate velocity field for illustration, without aspiring to represent a precise velocity field. In real flow measurements, a person of ordinary skill would have a choice of interrogation software that produce much more precise information on velocity, vorticity, or other flow parameters. Furthermore, the illustrated experiment illustrates one line of laser-generated fluorescence. A person of ordinary skill would understand that a pattern (grid) of light beams in the flow of the gas can also be generated by suitable optical elements 130, lenses 190, mirrors, and/or other optical devices.

The left-hand side graph presents an average raw image of the tagged lines after background luminescence subtraction. As the freestream flow contains minimal high-temperature chemical effects, almost all NO is formed behind the bow shock in front of the blunt nose of the model, where the static temperature may rise to 4,200 K. This results in the NO being located primarily between the oblique shock and the model surface. A 2-D Gaussian filter (3-pixel sigma) and a 2-mm vertical moving average were then used on background-subtracted images to reduce the intensifier-induced noise. A Gaussian function fit was then applied for each pixel row to identify the centroids for both tagged lines. In order to mitigate synthetic calculated velocity fluctuations due to the fitting routine, the first tagged line centroids were fitted with a straight line, following the assumption of straight beam propagation and minimal displacement after 200 ns. The resulting tagged line centroids overlapping the raw image are presented in the right-hand graph.

The velocity profile near the hypersonic model can be calculated by the displacement between the two tagged line centroids and divided by the temporal delay between the two intensifier gate centers. However, the X-Y-Z Cartesian coordinate system, in which the positions and tagged line displacement were calculated, needs to be transformed into the cylindrical coordinate system with respect to the model, assuming an axisymmetric flow around an ogive, as presented in Eqs. 1 and 2 below. Here, y is a position along the Y axis with respect to the point closest to the model surface, R=43 mm is the model radius, h₀ is the smallest distance to the model surface, and H is the radial height above the model at a given position y.

$$θ = arctan ( \frac{y}{R + {h}_{o}} ) \qquad ( 1 )$$

$$H = \frac{y}{sin θ} - R \qquad ( 2 )$$

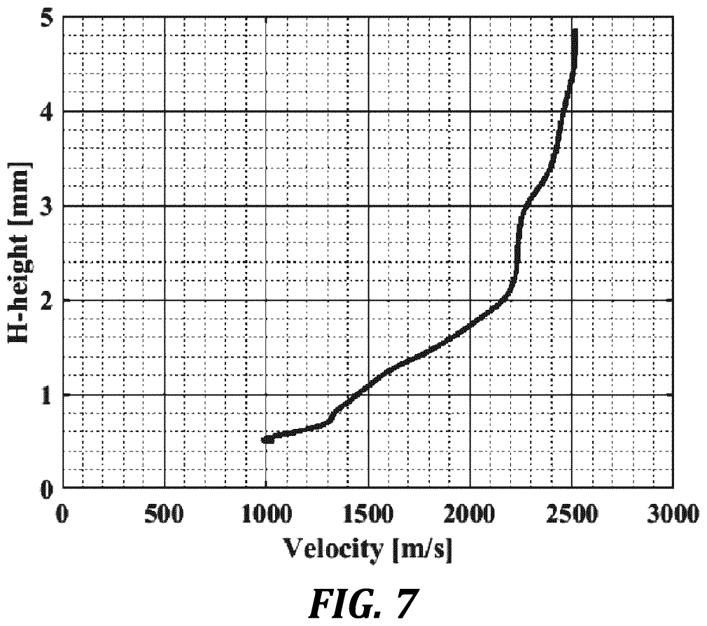

FIG. 7 shows experimental results of velocity measurements shown in FIG. 6. In particular, FIG. 7 shows an average velocity profile measured as a function of radial height above the model (H). The velocity outside the boundary layer as fast as 2516 m/s was measured at 4.7 mm above the model surface. The velocity of 985 m/s was measured as close as 0.5 mm to the surface. An additional benefit of the tangential tagging to the model is the “stretching” of the boundary layer region, for instance, the 4 mm boundary layer measured for Condition 1 was “stretched” over 12 mm in the Cartesian coordinate system as captured by the camera. Fluorescence decay calculated based on 0.6 and 5.6 ms gates was equal to

$$4 μ s ( \frac{1}{e} ) .$$

The underprediction of velocity due to fluorescence decay is estimated at 15 m/s (˜0.5%), which is statistically insignificant and is considered negligible. This result compares well with the results obtainable by FLEET method, which in some cases result in 10% error for very swiftly decaying nitric oxide UV fluorescence (˜100 ns), or 3% error for the FLEET in air (˜400 ns (1/e) decay). This makes NiiFTI advantageous for long delays between camera gates and simplified post-processing, which does not require additional fluorescence decay quantification.

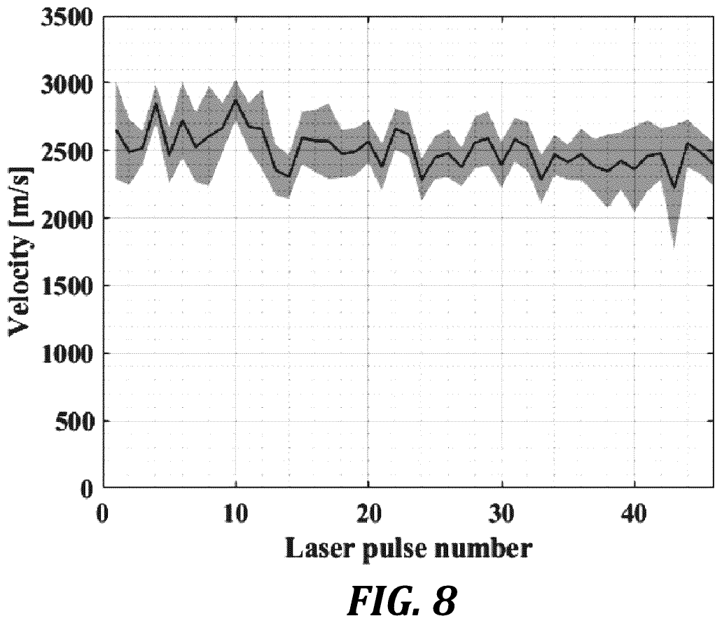

FIG. 8 shows experimental results of velocity measurements in accordance with embodiments of the present technology. In particular, the illustrated graph shows a single shot (a single laser pulse) flow velocity outside the boundary layer at Mach 10. This case is labeled as Condition 2 in Table 1. The laser beam is focused around 1-1.5 mm away from the model surface. The region outside the boundary layer is averaged for single-shot images before performing the tagged line fitting algorithm. It was observed that the amount and spatial distribution of the NO in the flow behind the shock front fluctuated substantially. The nitric oxide fluctuations were attributed to the shock front motion due to the acoustic disturbances propagating through the tunnel. The images with no or negligible amount of NO in the laser beam path were removed from further analysis. The resulting single-shot velocity measurement above the boundary layer is shown with the uncertainty band based on Gaussian fit 95% confidence interval presented by the shaded region (˜200 m/s). The velocity has a minor decelerating trend across the test time with the mean velocity for the first 20 and the last 20 shots being 2580 m/s and 2440 m/s respectively. The trend is attributed to a minor flow cooling during the test time which was also observed with a static pressure trace. The velocity standard deviation is quantified at around 5% (˜140 m/s) which is comparable to the static pressure fluctuations and, hence is attributed to the flow behavior.

In general, the above experimental results obtained by NiiFTI demonstrate a good performance, especially so in high-enthalpy hypersonic flow, extending its usability to reacting environments.

The presently disclosed and/or claimed inventive concept(s) is capable of other embodiments or of being practiced or carried out in various ways. Also, it is to be understood that the phraseology and terminology employed herein is for the purpose of description and should not be regarded as limiting. Unless otherwise defined herein, technical terms used in connection with the presently disclosed and/or claimed inventive concept(s) shall have the meanings that are commonly understood by those of ordinary skill in the art. Further, unless otherwise required by context, singular terms shall include pluralities and plural terms shall include the singular.

As utilized in accordance with the present disclosure, the following terms, unless otherwise indicated, shall be understood to have the following meanings.

The use of the word “a” or “an” when used in conjunction with the term “comprising” may mean “one”, but it is also consistent with the meaning of “one or more”, “at least one”, and “one or more than one”. The use of the term “or” is used to mean “and/or” unless explicitly indicated to refer to alternatives only if the alternatives are mutually exclusive, although the disclosure supports a definition that refers to only alternatives “and/or”. Throughout this application, the term “about” is used to indicate that a value includes the inherent variation of error for the quantifying device, the method being employed to determine the value, or the variation that exists among the study subjects. For example, but not by way of limitation, when the term “about” is utilized, the designation value may vary by plus or minus twelve percent, or eleven percent, or ten percent, or nine percent, or eight percent, or seven percent, or six percent, or five percent, or four percent, or three percent, or two percent, or one percent. The use of the term “at least one” will be understood to include one as well as any quantity more than one, including but not limited to, 2, 3, 4, 5, 10, 15, 20, 30, 40, 50, 100, etc. The term “at least one” may extend up to 100 or 1000 or more, depending on the term to which it is attached; in addition, the quantities of 100/1000 are not to be considered limiting, as lower or higher limits may also produce satisfactory results. In addition, the use of the term “at least one of X, Y, and Z” will be understood to include X alone, Y alone, and Z alone, as well as any combination of X, Y, and Z. The use of ordinal number terminology (i.e., “first”, “second”, “third”, “fourth”, etc.) is solely for the purpose of differentiating between two or more items and is not meant to imply any sequence or order or importance to one item over another or any order of addition, for example.

As used herein, the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps. The term “or combinations thereof” as used herein refers to all permutations and combinations of the listed items preceding the term. For example, “A, B, C, or combinations thereof” is intended to include at least one of: A, B, C, AB, AC, BC, or ABC and, if order is important in a particular context, also BA, CA, CB, CBA, BCA, ACB, BAC, or CAB. Continuing with this example, expressly included are combinations that contain repeats of one or more item or term, such as BB, AAA, AB, BBC, AAABCCCC, CBBAAA, CABABB, and so forth. The skilled artisan will understand that typically there is no limit on the number of items or terms in any combination, unless otherwise apparent from the context.

In the context of this disclosure, the terms “about,” “approximately,” “generally” and similar mean+/−5% of the stated value.

Many embodiments of the technology described above may take the form of computer- or controller-executable instructions, including routines executed by a programmable computer or controller. Those skilled in the relevant art will appreciate that the technology can be practiced on computer/controller systems other than those shown and described above. The technology can be embodied in a special-purpose computer, controller or data processor that is specifically programmed, configured or constructed to perform one or more of the computer-executable instructions described above. Accordingly, the terms “computer” and “controller” as generally used herein refer to any data processor and can include Internet appliances and hand-held devices (including palm-top computers, wearable computers, cellular or mobile phones, multi-processor systems, processor-based or programmable consumer electronics, network computers, mini computers and the like).

From the foregoing, it will be appreciated that specific embodiments of the technology have been described herein for purposes of illustration, but that various modifications may be made without deviating from the disclosure. Moreover, while various advantages and features associated with certain embodiments have been described above in the context of those embodiments, other embodiments may also exhibit such advantages and/or features, and not all embodiments need necessarily exhibit such advantages and/or features to fall within the scope of the technology. Accordingly, the disclosure can encompass other embodiments not expressly shown or described herein.

What is claimed is:

1. A method for characterizing a flow of a gas containing an agent, the method comprising:
ionizing the agent by a source of pulsed light emitting at a frequency overlapping a resonant transition frequency of the agent;
in response to ionizing the agent, generating a fluorescence of the gas;
capturing at least one time-delayed image of the flow of the gas, wherein the capturing is time-delayed with respect to a pulse of the source of pulsed light; and
determining at least one property of the flow of the gas by analyzing the at least one time-delayed image of the flow.

2. The method of claim 1, further comprising:
transferring the frequency of the source of pulsed light to a resonant transition frequency of the agent by a wavelength tuning device that is an optical parametric oscillator (OPO).

3. The method of claim 1, further comprising:
transferring the frequency of the source of pulsed light to the resonant transition frequency of the agent by a wavelength tuning device that is a frequency upconverted dye laser.

4. The method of claim 1, wherein ionizing of the agent comprises:
generating a pattern of one or more light beams in the flow of the gas.

5. The method of claim 4, wherein the pattern of one or more light beams in the flow of the gas is configured at least partially within a boundary layer of a test article.

6. The method of claim 4, wherein the flow is a hypersonic flow.

7. The method of claim 1, wherein the source of pulsed light is a laser.

8. The method of claim 7, wherein the laser is configured to generate pulses having sub-milli Joule energy.

9. The method of claim 7, wherein the laser is configured to generate pulses in a 100 kHz-250 kHz range.

10. The method of claim 1, wherein ionizing comprises:
a first resonant excitation step; and
a second ionization step.

11. The method of claim 10, wherein:
the first resonant excitation step comprises a single or multi photon resonant excitation of the agent; and
the second ionization step comprises ionization of the agent.

12. The method of claim 1, wherein the agent comprises nitric oxide (NO) molecules.

13. The method of claim 12, wherein the gas comprises nitrogen (N2).

14. The method of claim 1, wherein capturing the at least one time-delayed image of the flow of the gas comprises a single imaging after a predefined time-delay following ionizing of the agent.

15. The method of claim 1, wherein capturing the at least one time-delayed image of the flow of the gas comprises:
a first imaging after a first time-delay; and
a second imaging after a second time-delay, wherein the second time-delay is greater than the first time-delay.

16. The method of claim 15, wherein the first imaging and the second imaging are captured within a single camera frame that spans over the first time-delay and the second time-delay.

17. The method of claim 15, wherein the first imaging and the second imaging are captured within separate camera frames that are individually time-delayed.

18. A system for characterizing a flow of a gas containing an agent, the system comprising:
a source of pulsed light configured for emitting light at a first frequency;
a wavelength tuning device configured for receiving the pulsed light at the first frequency, and for emitting the pulsed light at a frequency overlapping a resonant transition frequency of the agent, wherein, in response to ionization of the agent, a fluorescence of the gas is generated; and
a camera configured for capturing at least one image of the flow of the gas, wherein the capturing is time-delayed with respect to pulses of the pulsed light; and
a controller configured for determining at least one property of the flow of the gas by analyzing the at least one image of the flow.

19. The system of claim 18, wherein the wavelength tuning device is an optical parametric oscillator (OPO).

20. The system of claim 18, wherein the wavelength tuning device that is a frequency upconverted dye laser.

21. The system of claim 18, further comprising:
an optical system configured for generating a pattern of one or more light beams in the flow of the gas.

22. The system of claim 18, wherein the source of pulsed light is a laser.

23. The system of claim 22, wherein the pulses have a sub-milli Joule energy content.

24. The system of claim 22, wherein the pulses have a frequency in a 100 kHz-250 kHz range.

25. The system of claim 18, wherein the agent comprises nitric oxide (NO) molecules.

26. The system of claim 18, wherein the gas comprises nitrogen (N2).
